(19) United States
(12) Patent Application Publication
(10) Pub. No.: US 2009/0231148 A1
(43) Pub. Date: Sep. 17, 2009

(54) STRUCTURE FOR DISPLAYING OPERATION STATUS OF A POWER SUPPLY

(75) Inventor: Shih-Hsien YU, Taipei (TW)

Correspondence Address: Muncy, Geissler, Olds & Lowe, PLLC, P.O. BOX 1364, FAIRFAX, VA, 22038-1364, US

(73) Assignee: SHUTTLE INC.

(21) Appl. No.: 12/046,032

(22) Filed: Mar. 11, 2008

(51) Int. Cl. G08B 17/06

(52) U.S. Cl. 340/595

(57) ABSTRACT

The present invention provides a power source to transform external power to DC driving power and has an air fan and a fan driving circuit connecting to a detection element to detect operation temperature inside the power supply and output a temperature control signal. Through the temperature control signal, the DC driving power is determined to drive the air fan at a required rotation speed. The power supply further has a status display circuit which includes at least two switches and two lighting elements. The switches are set at different ON/OFF levels and triggered by the temperature control signal or the fan driving circuit to determine whether ON/OFF of the switches be activated. The lighting elements are connected to the switches and driven by the DC driving power to emit light in the ON condition of the switches.

### FIELD OF THE INVENTION

The present invention relates to a structure to display operation status of a power supply and particularly to a structure that displays operation status of the power supply while rotation speed of an air fan changes due to alterations of operation temperature in the power supply.

### BACKGROUND OF THE INVENTION

A general power supply usually receives city power and transforms to DC power to provide electric power needed in a computer system. Nowadays due to performances of various devices in the computer system such as CPU, hard-disk drives, display cards and the like increase continuously, the power supply also has to provide greater output power to meet those requirements. The power supply of a greater output power generates a greater amount of heat and results in a higher operation temperature.

To overcome the problem of higher operation temperature of the power supply and enable the power supply to provide a desired amount of electric power required in a computer system, an intelligent power supply has been developed. It mainly has a sensor to detect the internal temperature of the power supply. In the event that the loading power of the power supply increases and results in a higher internal temperature, the sensor outputs a detection signal to drive a fan control circuit to increase the rotation speed of an air fan to quickly lower the operation temperature. In addition, to allow users to be informed of output power, temperature or air fan rotation speed of the power supply while the computer is operating, it also has a display device connecting to a first side or a second side thereof to display operation status of the power supply. For instance, R.O.C. patent No. M258494 entitled: “Power supply equipped with loading condition display function” discloses a power supply connecting to a loading display interface. The loading display interface is connected to a linear commutation circuit which is coupled with an output end of a power factor connection circuit located in the power supply. The linear commutation circuit captures output power of the power supply in a use condition and transmits to the loading display interface to display the value to inform users.

Although the aforesaid patent provides the power supply equipped with the loading display interface to enable the users to timely get the operation status of the power supply, to display the power value or amount of the power supply through the loading display interface requires adding the linear commutation circuit. Such a structure makes circuit design of the power supply more difficult.

### SUMMARY OF THE INVENTION

The primary object of the present invention is to solve the aforesaid disadvantages. The invention provides a structure to display operation status of a power supply that is integrated in a fan driving circuit of a conventional intelligent power supply. The structure, exploiting the relationship of change of rotation speed of an air fan caused by alteration of operation temperature of the power supply, simulates and displays the operation status of the power supply to simplify circuit design.

To achieve the foregoing object, the power supply of the invention provides a power source to transform external power to DC driving power. The power supply has an air fan and a fan driving circuit which is connected to a detection element to detect operation temperature inside the power supply and output a temperature control signal. Through the temperature control signal, the fan driving circuit determines a DC driving power to drive the air fan to achieve a required rotation speed. The power supply further has a status display circuit which includes at least two sets of switches and lighting elements. The switches are set at different ON/OFF levels and triggered by the temperature control signal or the fan driving circuit to determine whether ON/OFF of the switches be activated. The lighting elements are connected to the switches and driven by the DC driving power to emit light in the ON condition of the switches. Hence when temperature changes and the rotation speed of the fan is altered, the status display circuit at the same time drives the lighting elements to alter and display the operation status of the power supply. Thus, there is no need to design an additional circuit to connect to the first side or second side of the power supply. The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a structural block diagram of the invention.

FIG. 2 is a perspective view of an embodiment of the invention.

FIGS. 3A, 3B and 3C are schematic views of the invention in use conditions.

### DETAILED DESCRIPTION OF THE PREFERRED EMBODIMENT

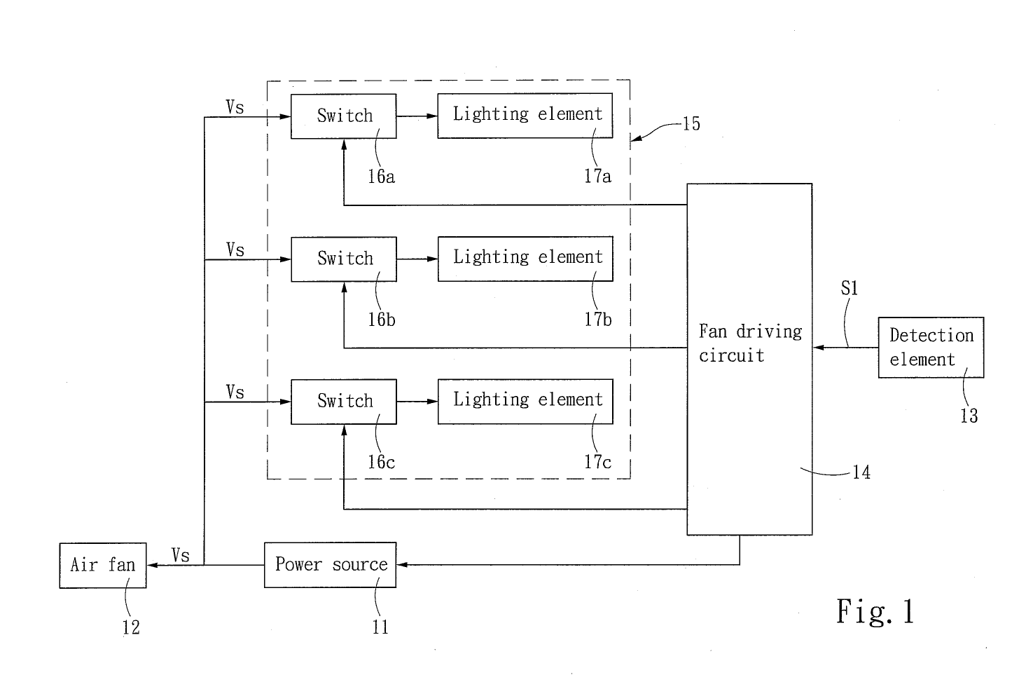

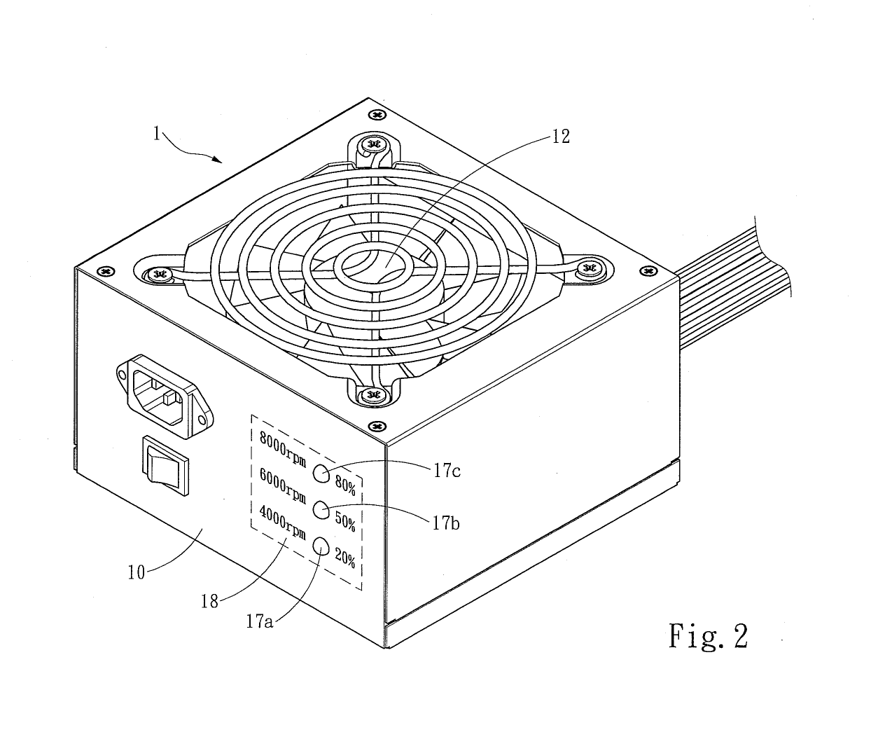

Please refer to FIGS. 1 and 2 for the structure for displaying operation status of a power supply according to the invention. The power supply 1 includes a power source 11 to transform external power to DC driving power Vs, an air fan 12 and a fan driving circuit 14. The fan driving circuit 14 is connected to a detection element 13 to detect operation temperature inside the power supply 1 and output a temperature control signal S1. The fan driving circuit 14 controls the amount of the DC driving power Vs according to the temperature control signal S1 to alter the rotation speed of the air fan 12. Namely, in the event that the operation temperature of the power supply 1 is higher, the rotation speed of the air fan 12 also increases. It is to be noted that the power supply 1 also has a status display circuit 15 which includes at least two switches 16a, 16b and 16c connecting respectively to lighting elements 17a, 17b and 17c. The switches 16a, 16b and 16c are set at different ON/OFF levels and triggered by the temperature control signal S1 or the fan driving circuit 14 to become ON or OFF conditions. The lighting elements 17a, 17b and 17c are LEDs or lighting bulbs installed on a face panel 10 of the power supply 1. When the switches 16a, 16b and 16c are set ON, they receive the DC driving power Vs to drive the lighting elements to emit light. There are labels 18 on the face panel 10 at one side of the lighting elements 17a, 17b and 17c to indicate the rotation speed of the air fan 12 and power status of the power supply 1. Thus when the operation temperature of the power supply 1 changes and the rotation speed of the air fan 12 alters, and at the same time the status display circuit 15 drives the lighting elements 17a, 17b and 17c to change display to indicate the operation status of the power supply 1.

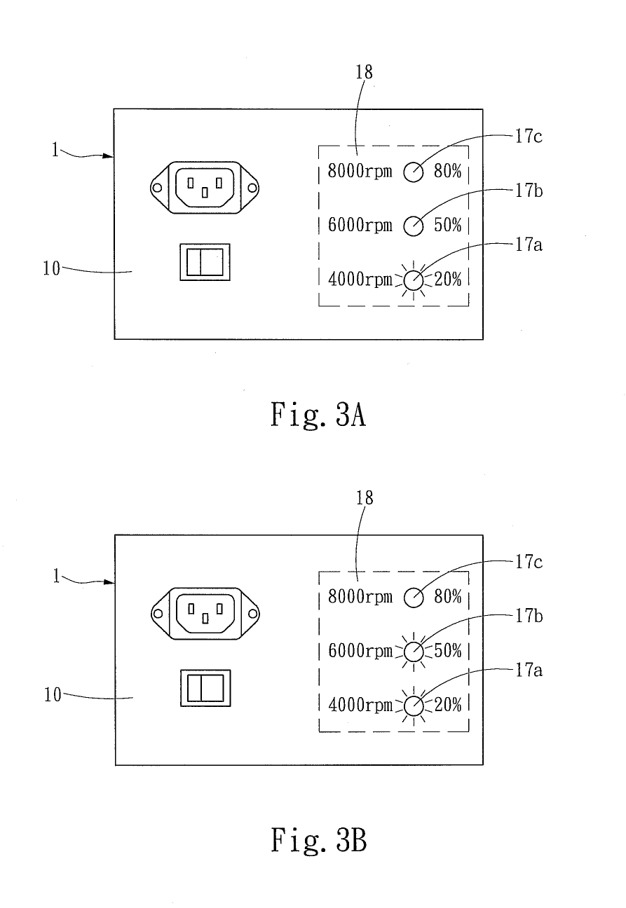

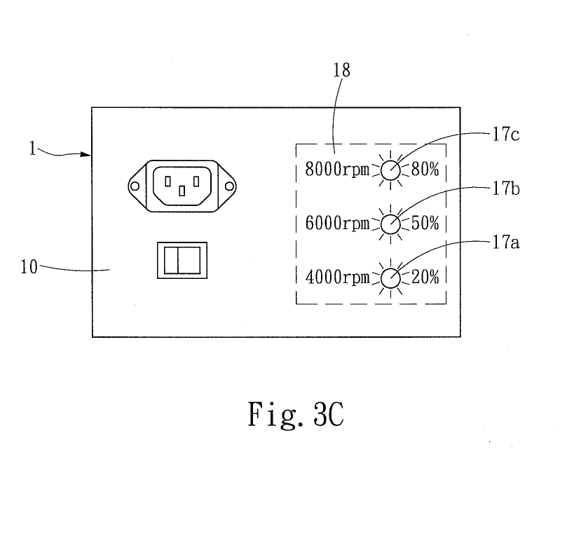

In an embodiment of the invention, setting ON levels of the switches 16a, 16b and 16c are defined as 16c>16b>16a. The threshold values of ON are defined respectively 20%, 50% and 80% of the power of the power supply 1. When the power of the power supply 1 increases to 20%, the operation temperature of the power supply 1 increases, and the detection element 13 outputs the temperature control signal S1 to the fan driving circuit 14 to trigger the switch 16a ON so that the DC driving power Vs drives the lighting element 17a to emit light, while other switches 16b and 16c are still OFF due to they have higher ON levels and other lighting elements 17b and 17c remain OFF (referring to FIG. 3A). When the power of the power supply 1 increases to 50% to meet user's requirement, the switches 16a and 16b are driven by the temperature control signal S1 or the fan driving circuit 14 to set ON, and the DC driving power Vs drives the lighting elements 17a and 17b to emit light, meanwhile other switch 16c is still OFF and other lighting element 17c also remains OFF (referring to FIG. 3B). In the event that the power of the power supply 1 continuously increases to 80%, the switches 16a, 16b and 16c. are set ON together, and the lighting elements 17a, 17b and 17c are driven by the DC driving power Vs at the same time to emit light (referring to FIG. 3C). Thus users can be informed of the current power status, operation temperature or rotation speed of the air fan 12 of the power supply by referring to the lighting elements 17a, 17b and 17c on the face panel 10. Moreover, the status display circuit 15 also drives the lighting elements 17a, 17b and 17c to alter lighting when the operation temperature of the power supply 1 changes that results in alteration of the rotation speed of the air fan 12 to display the operation status of the power supply 1.

As a conclusion, when the loading power of the power supply 1 increases the operation temperature also increases, then the fan driving circuit 14 drives the air fan 12 to increase the rotation speed. There is a corresponding relationship in terms of increase and decrease between the loading power of the power supply 1 and the rotation speed of the air fan 12. The invention exploits such a characteristic to integrate the status display circuit 15 with the fan driving circuit 14 so that when the rotation speed of the air fan 12 changes due to temperature alteration, the switches 16a, 16b and 16c also are triggered to set ON by the fan driving circuit 14 or the temperature control signal S1 to allow the DC driving power Vs to drive the lighting elements 17a, 17b and 17c to emit light to simulate and display the operation status of the power supply 1. Thus there is no need to install an additional output power acquiring means on the power supply 1 to free from the problem of complicated circuit design.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A structure for displaying operation status of a power supply which provides a power source to transform external power to DC driving power and has an air fan and a fan driving circuit connecting to a detection element to detect operation temperature inside the power supply and output a temperature control signal, the fan driving circuit determining the DC driving power to drive the air fan to get a desired rotation speed through the temperature control signal, the structure comprising:
a status display circuit in the power supply that includes at least two switches and two lighting elements, the switches being set at different ON/OFF levels and triggered by the temperature control signal or the fan driving circuit to determine whether ON/OFF of the switches be activated, the lighting elements being connected to the switches and driven by the DC driving power to emit light in the ON condition of the switches, the status display circuit driving the lighting elements to display operation status of the power supply when the rotation speed of the air fan alters.

2. The structure of claim 1, wherein the lighting elements are light emitting diodes.

3. The structure of claim 1, wherein the lighting elements are lighting bulbs.

4. The structure of claim 1, wherein the power supply has a face panel to hold the lighting elements.

5. The structure of claim 4, wherein the face panel has labels located at one side of the lighting elements to indicate the status.
